(19) United States
(12) Patent Application Publication
(10) Pub. No.: US 2008/0242315 A1
(43) Pub. Date: Oct. 2, 2008

(54) Traffic data collection utilizing a cellular communication network and probe units

(75) Inventor: Martin A. Ferman, Huntington Woods, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/691,531

(22) Filed: Mar. 27, 2007

(51) Int. Cl. H04Q 7/22

(52) U.S. Cl. 455/456.2; 379/112.01

(57) ABSTRACT

A system for collecting request signal and probe data from telematics units using a cellular communication network, wherein the units each cause to be transmitted registration request signal data to a carrier, the carrier periodically compiles a cell history log comprising a list of cell hand-offs for each unit, and a facility is communicatively coupled to the carrier; includes map and unit identification databases; is configured to determine cell-handoffs of interest; preferably queries the carrier for only target units presenting a cell-handoff of interest; determines for each target unit a recently traveled path (RTP) based on the log, an estimated time of travel (ETT) based on the RTP and map database, and a probe unit status; calls each probe unit to upload probe data therefrom; and utilizes the probe data to enhance the ETT or provide additional information.

### BACKGROUND OF THE INVENTION

1. Field of the Invention

The present invention pertains generally to traffic management and information systems, and more particularly to a method of targeting and tracking a mobile telematics unit.

2. Discussion of Prior Art

Conventional traffic management and navigational systems have been developed to improve vehicular travel on mapped thoroughfares (i.e., roads, streets, boulevards, highways, etc.) by providing vehicular units with real-time traffic information. Typically these systems utilize one or more probe vehicles equipped with particularized data collection modules, including a global positioning system (GPS) receiver, and a communication sub-system for transmitting intra-vehicular and/or exterior traffic data to and receiving instructions from a traffic management center (TMC).

However, periodically and sometimes continuously transmitting location data from millions of vehicles can result in large wireless communication costs and potentially burden the cellular network. Various methods have been proposed whereby the vehicle would determine if and when it should transmit its data, so that less interesting data need not be transmitted. These approaches all require additional onboard capabilities, generally including additional hardware and software, with concomitantly increased costs (and significant delays in implementation). Another approach requires that the central sever maintain records of the past driving history and likely routes of each vehicle, so that it can call those vehicles that are likely to be on the roads of interest. But this approach has serious privacy concerns and probably can only be used for captive fleets. Further, substantial operating costs often result, because probe vehicles are not initially eliminated when outside of the relevant geographic scope of the inquiry.

Thus, although effective, conventional systems present cost concerns associated with implementation and operation, resulting in a continued need in the art for an easier to implement and more efficient method of providing real-time traffic information to vehicles.

### BRIEF SUMMARY OF THE INVENTION

Responsive to these concerns, the present invention provides methods of collecting data from a target unit, wherein the unit includes a cellular communication device that at least periodically sends registration request signal data to a carrier. The carrier determines a current cellular communication cell serving the unit based on the registration request signal data, and compiles a cell history log for the unit that includes a list of cells within which the unit transmitted within a preceding period. A third-party facility such as a TMC communicates with the carrier and unit, and is configured to primarily perform the method.

Generally, the method includes determining a desired inquiry path at the facility. Registration request signal data is monitored and a cell history log for at least one unit is compiled at the carrier. The registration request signal data and history log are received at the facility. A transmission location, transmission time and unit phone number are determined based on the registration request signal data. A recently traveled path based on the list of cells is estimated. The desired inquiry and recently traveled paths are compared, so as to determine a target unit. Finally, an estimated travel time for traversing the estimated recently traveled path is determined based in part on the registration request signal data or history log and a map database at the facility.

In other aspects of the invention, probe vehicle determination and use are included in the method so as to refine the estimated travel time and provide additional probe data collection. In one example, the method further includes calling the probe unit at the facility to establish a communication link, determining probe data at the unit, and uploading the data to the facility. The probe data may include the current vehicular location, speed, heading, temperature, windshield wiper actuation status, and fog light actuation status.

The present invention provides advantages over and benefits inconsistent with prior art traffic management systems. Among other things, the invention is useful for providing a system wherein software or hardware additions are not required when the unit includes a cellular communication device. In other words, the invention takes advantage of existing cellular network communication systems to provide a more cost effective traffic information and management system. Further, the invention is further useful for significantly reducing wireless communications and associated costs typically experienced with prior art systems, by selectively targeting probe units prior to generating a direct communication link therewith. As such, the inventive system is useful for providing less burden on cellular networks compared to conventional probe systems, and more accurate traffic information compared to non-GPS probe systems. The system works at any probe penetration level, whereas performance increases with penetration, but no minimum level is required. Finally, the system provides flexibility to dynamically self-tune and/or focus areas of interest, and provides critical information for refining hand-off algorithms.

Other aspects, embodiments, and advantages of the present invention will be apparent from the following detailed description of the preferred embodiment(s) and the accompanying drawing figures.

### BRIEF DESCRIPTION OF THE SEVERAL VIEWS OF THE DRAWING

A preferred embodiment(s) of the invention is described in detail below with reference to the attached drawing figures, wherein:

FIG. 1 is a generalized elevation view of a target vehicular unit, a requesting vehicular unit, a carrier, and a third-party facility in accordance with a preferred embodiment of the present invention, particularly illustrating the communication links therebetween;

FIG. 1a is a schematic plan view of the target unit shown in FIG. 1;

FIG. 2 is a pedagogical cellular map depicting pluralities of adjacent cells and interconnecting thoroughfares, a DIP, and at least one requesting unit and target unit, in accordance with a preferred embodiment of the present invention;

FIG. 3 is a generalized elevation view of a probe vehicular unit, a requesting vehicular unit a carrier, and a third-party facility in accordance with a preferred embodiment of the present invention, particularly illustrating the communication links there between;

FIG. 3a is a schematic plan view of a probe vehicular unit equipped to participate in the preferred embodiments shown in FIGS. 1 and 2, further illustrating diagrammatic representation of a digital signal processor (DSP) connected to a wireless modem, a global positioning system (GPS) receiver, a memory, a microphone, at least one speaker, an embedded or in-vehicle phone, and at least one sensor for obtaining probe data;

FIG. 3b is a schematic view of the facility in accordance with a preferred embodiment of the present invention, particularly illustrating a map database, identification database, electronic control unit (ECU), and communication links in relation thereto;

FIG. 4 is a generalized elevation view of a vehicle unit serving as a monitor in accordance with a preferred embodiment of the present invention, particularly illustrating a plurality of lower-powered transmitting probe vehicles and the facility communicatively coupled to the monitor unit;

FIG. 5 is a flowchart of a method of data collection in accordance with a preferred embodiment of the invention wherein the facility receives signal data from all communicating units, but only probe vehicular units are utilized;

FIG. 6 is a flowchart of a method of data collection in accordance with a preferred embodiment of the present invention wherein target vehicles are selectively retrieved, and only probe vehicular units are utilized; and

FIG. 7 is a flowchart of a method of data collection in accordance with a preferred embodiment of the present invention, wherein cellular data is utilized to generate estimated travel times and where available, actual probe vehicle data is used to enhance the estimates.

### DETAILED DESCRIPTION OF THE INVENTION

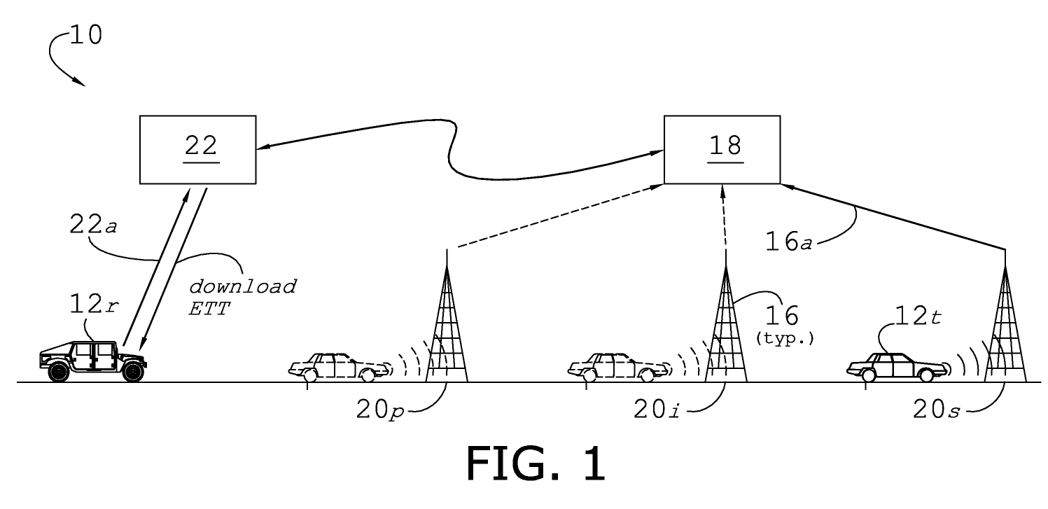

As shown in the illustrated embodiments (FIGS. 1 through 4), the present invention concerns a system 10 and method of determining an estimated travel time and/or further probe data associated with at least one telematics unit 12. Generally, the unit 12 includes a cellular communication device (or phone) 14 that, once having received a matching SID, periodically sends registration request signals (shown as hidden lines in FIGS. 1,3 and 4) to a nearest cell tower 16. The tower 16 modifies the signal and transmits registration request signal data 16a to a carrier 18 (or more particularly to a mobile telephone switching office (MTSO) of a wireless service provider).

The carrier 18 records and utilizes the signal data to determine the servicing geographic cell 20 (as defined by the location of the tower 16 in conjunction with the location of neighboring towers), so as to economically and efficiently complete a page or call directed towards the unit 12. As the unit 12 travels geographically, the unit 12 traverses or crosses into a plurality of adjacent cells 20 (FIGS. 1, 2, and 3), unless the unit is turned off during a complete cellular crossing. The cells 20a within which the unit was present and transmitted are stored at the carrier 18 as what are commonly known as cell “hand-offs.” The visited cells 20a are further stored and recorded in a periodically updated cell history log at the carrier 18, wherein said log is matched to the unit 12.

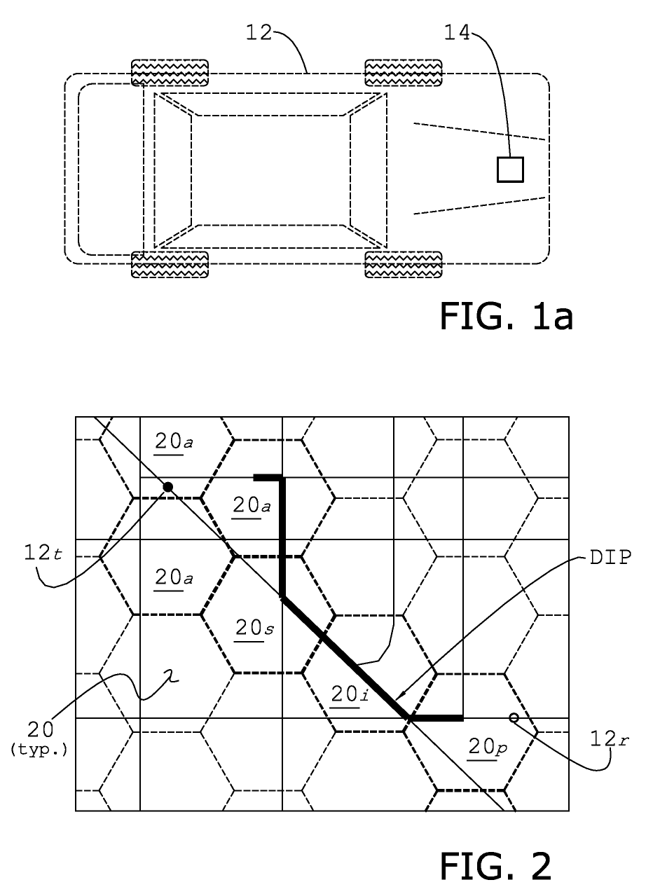

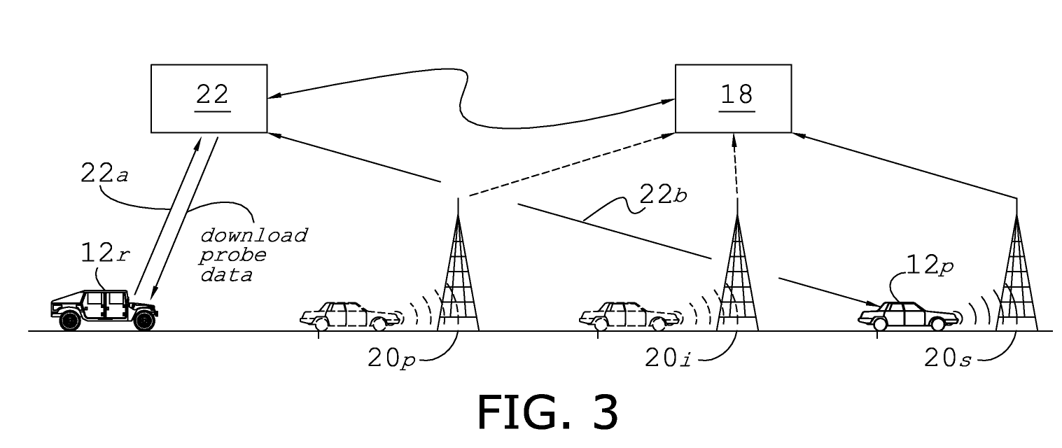

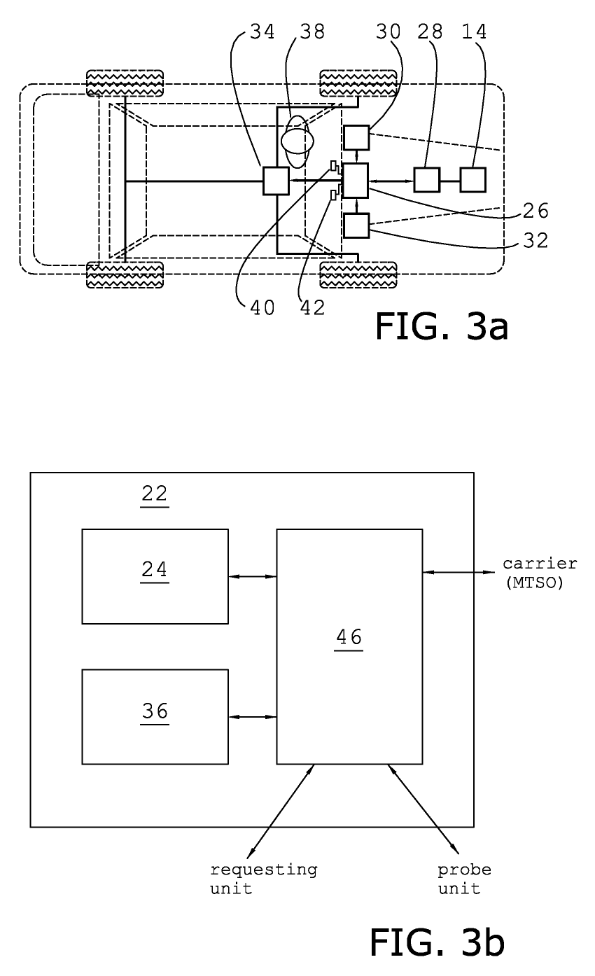

The system 10 includes a third-party facility 22, such as a TMC or “call center,” that is communicatively coupled to the carrier 18, and inventively configured to estimate a recently traveled path (RTP) for the unit 12 based on the cell log and a map database 24 of interconnecting cellular thoroughfares (FIG. 2), determine whether the unit 12 presents a target unit 12t based on the RTP and a previously determined desired inquiry path (DIP), and determine an estimated travel time (ETT) for the target unit 12t also based on the signal data and RTP. The estimated travel time can then be used to inform a requesting unit 12r (FIGS. 1 and 3), wherein said requesting unit 12r is defined by another unit 12 or entity desiring the ETT for the RTP that sends a request 22a for the same to the facility 22.

The preferred facility 22 is configured to receive the request 22a, determine the desired inquiry path based on the request 22a and map database 24, determine the cells circumscribing the desired inquiry path, and send a query to the carrier 18 for only those electronic serial numbers having cell logs containing hand-offs between at least a portion of the circumscribing cells. Having satisfied the query, these units 12 are deemed target units 12t.

The preferred facility 22 is further configured to determine whether a target unit 12t is also an equipped probe unit 12p (FIGS. 3 and 3a). Where a probe unit 12p is determined, the facility 22 calls the unit 12p to establish a data transfer link and uploads probe data about the operation, condition, and/or status of the unit 12p. That is to say, the system 10 uses cell phone hand-off data to help decide which probes 12p to call for data on current traffic, weather and other types of road and vehicle information. Finally, the preferred system 10 is further configured to relay the ETT, probe data, or a combination of the two to the requesting unit 12r.

Thus, the system 10 is generally configured to function as a TMC or information service that takes advantage of pre-existing and increasingly omnipresent cellular communications networks to derive the traffic information of interest. The system 12 is described and illustrated herein with respect to a vehicular unit 12 (i.e., where the unit 12 is housed within a vehicle), such as a motorcycle, car, SUV, or truck. However, it is appreciated by those of ordinary skill in the art that the advantages and benefits of the present invention may be utilized in other applications featuring mobile units having cellular communication and positioning capabilities, such as implantation devices, cellular telephones, PDA's, and/or smart devices containing GPS technology. It is also appreciated that the present invention offers further non-obvious and distinguishable functionality, configuration, and capabilities, in comparison to a system or method of identifying and/or simply tracking the location of units using registration request signal data, which is known in the art. For example, U.S. Pat. No. 6,853,910 to Oesterling et al., the teachings of which are incorporated herein by reference in their entirety, discloses various embodiments of a system and method of tracking the general location of a vehicle.

More particularly, each registration request signal includes, among other things, an electronic serial number singularly associated with the transmitting unit 12, and the transmission time of the signal, which includes the date and time. At the tower 16, the request signal is appended with the tower location or a tower identifier, wherein the later configuration the identifier can be matched at the carrier 18 to a previously inputted or determined tower location, so as to determine a transmission location. As previously mentioned, the carrier 18 functions to determine a current cellular communication cell serving the unit 12 based on the transmission location of the signal data, and then adds the cell to the cell history log for the unit 12. The cell log comprises a list of the cells within which the unit transmitted within a preceding period.

After the period the log begins to circulate by replacing the last entry with the current. For the intents and purposes of the present invention, the period is configured to provide meaningful data. In other words, the period of recordation is such that the unit 12 is able under regularly anticipated speeds to traverse a minimum number of cells. For example, where cells average approximately ten square miles and present hexagonal configurations (FIG. 2), as is commonly designed, traversing maximum diameters of 1.5 to 2.0 miles are typically presented, and where a minimum number of three cells are desired to construct an estimated RTP, and a 30 mph average travel rate is utilized, a minimum period of 6 minutes, more preferably 12 minutes (including a factor of safety of 2 to accommodate up to halved travel rates), and most preferably 24 minutes (including a factor of safety of 4) is preferred.

The facility 22 includes a preferred algorithm for determining the ETT of a given thoroughfare (or link) based on the transmission times, cell information, and information obtained from the map database 24. As an example, one such method of calculating the ETT for an intra-cell link or segment is represented in FIG. 2, where a requesting vehicular unit 12r seeks travel time information that will help it decide whether to take an alternate route to its destination by making the next right, or to continue towards the diagonally extending highway. The requesting unit 12r sent the facility 22 a request 22a and a DIP was determined, wherein the end of the DIP is defined by the destination. Fortunately for the requesting unit 12r, another telematics unit is traveling on the highway and has just passed its location, thereby presenting a target unit 12t. The facility 22 obtained the cell history of the target unit 12t and determined a matching target for the highway segment of the DIP.

To calculate the ETT for traversing an interior adjacent cell 20i (i.e., when at least three adjacent cells are provided), the preferred algorithm takes the difference between the last transmission time in the preceding adjacent cell 20p and the first transmission time in the succeeding adjacent cell 20s (FIG. 2). It is appreciated that the calculated ETT, in this configuration, reflects an average crossing time for all of the (normally alternative) interconnecting routes passing through the interior cell 20i. The number of interconnecting routes through the cell 201 is not crucial to the functionality of the system 10, however, as it is also appreciated that traffic (or flow) between two points tends to equilibrate amongst the available conduits. More preferably, the preferred algorithm is configured to calculate the ETT only when the number of target units 12r considered exceed a multiple of the number of interconnecting routes. In FIG. 2, again the requesting unit 12r is fortunate in that the interior cell 20i presents only a single straight-through route (i.e., the highway) that interconnects the three cells, thereby increasing the accuracy of the estimate.

More preferably, and as shown in FIG. 3a, the preferred unit 12 is further equipped with a digital signal processor (DSP) 26 connected to a wireless modem 28, a global positioning system (GPS) receiver 30, a memory 32, and at least one condition sensor 34 operable to detect and convey to the memory 32 probe data. For example, in the illustrated embodiment, in addition to the GPS receiver 30, the vehicular unit 12 includes at least one and more preferably a plurality of sensors 34, such as a speedometer, thermometer, compass, yaw gyro, fog light actuation sensor, and windshield wiper actuation or precipitation sensor, operable to detect probe data, such as the current vehicular location, speed, heading, temperature, windshield wiper actuation status, and/or fog light actuation status. The preferred vehicular unit 12 may further include at least one analyzing module configured to determine probe data, such as a sustained hard-braking event, or unexpectedly below threshold travel rate indicative of traffic congestion.

The preferred units 12p are programmed to automatically read probe data including the GPS location data (longitude, latitude, heading, and time) every minute and store the data onboard in a circular buffer that maintains the past 10 minutes of information. More preferably, however, both the frequency and retention periods are adjustable so as to accommodate proper system performance (depending upon local, speed of travel, criticality, etc.) and/or user preference.

Thus, where properly equipped, the unit 12 is configuration to upload the probe data from the memory 30 to the facility 22 through the cellular communication device 14, DSP 26, and modem 28, so as to present a participating probe unit 12p. In this configuration, the facility 22 first matches the electronic serial number of the unit 12, as taken from the registration request signal data, with an identification number preferably obtained from a database 36. The database 36 is preferably stored at the facility 22, but may also be retrievable from a remote location. In the illustrated embodiment the identification number of the vehicle unit 12 is more commonly referred to as the VIN number. The identification number is then utilized to obtain the phone number of the unit 12. More particularly, the preferred database 36 further includes the phone number, so that both the identification and phone numbers are retrieved concurrently within the same record.

The preferred facility 22 is further configured to autonomously call the probe unit 12p using the phone number, so as to establish a communication link 22b with the probe unit 12p. As such, the facility is similarly equipped with a cellular communication device, modem, and DSP (not shown). Finally, so as to enable voice communications between the unit 12, facility 22, and a human operator 38 at the probe unit 12p, the probe unit 12p is preferably also equipped with a microphone 40, and at least one speaker 42 that are communicatively coupled to the DSP 26.

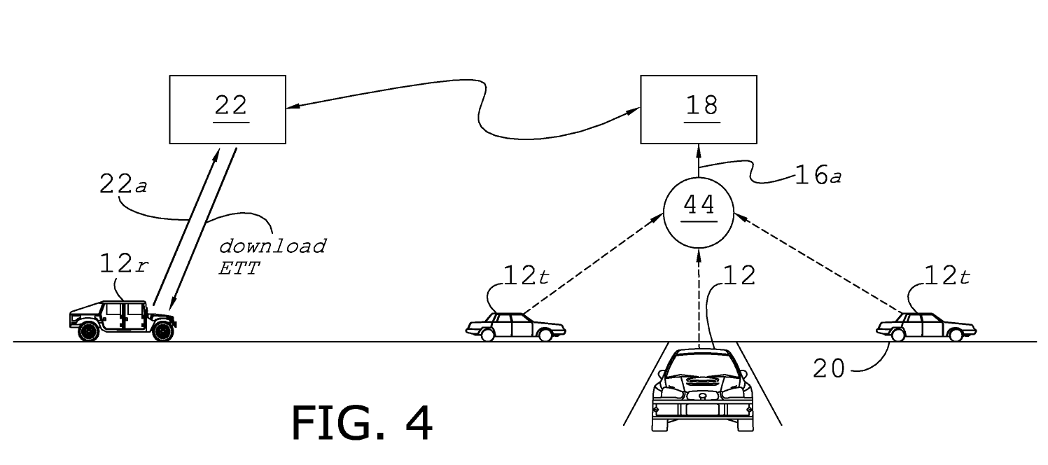

Alternatively, as shown in FIG. 4, an intermediary monitor 44 may be used in the place of or in addition to the tower 16. In this configuration the monitor 44 is similarly configured to receive, append its location or identifier to, and relay the registration request signal. An exemplary embodiment of this configuration wherein cell tower density is sparse may include a building, vehicle having an amplified transmitter, or other entity, especially equipped with receiver means for picking up registration request signals. The amplified vehicle unit, for example, may be configured to act as the monitor 44 where lower powered transmitting probe units, which are unable to reach the serving tower, are able to convey probe data to and convey their registration request signals through the monitoring vehicle.

The features and functionality of the preferred methods of operation of the present invention are designed to be executed from a computer usable medium storing a computer program, such as a compact disc, digital video disc, magnetic media, semiconductor memory, nonvolatile or permanent memory and autonomously by at least one electronic control unit 46 at the facility 22 and/or unit 12. As such, the facility 22 as well as the unit 12 contains the necessary software and hardware to perform accordingly.

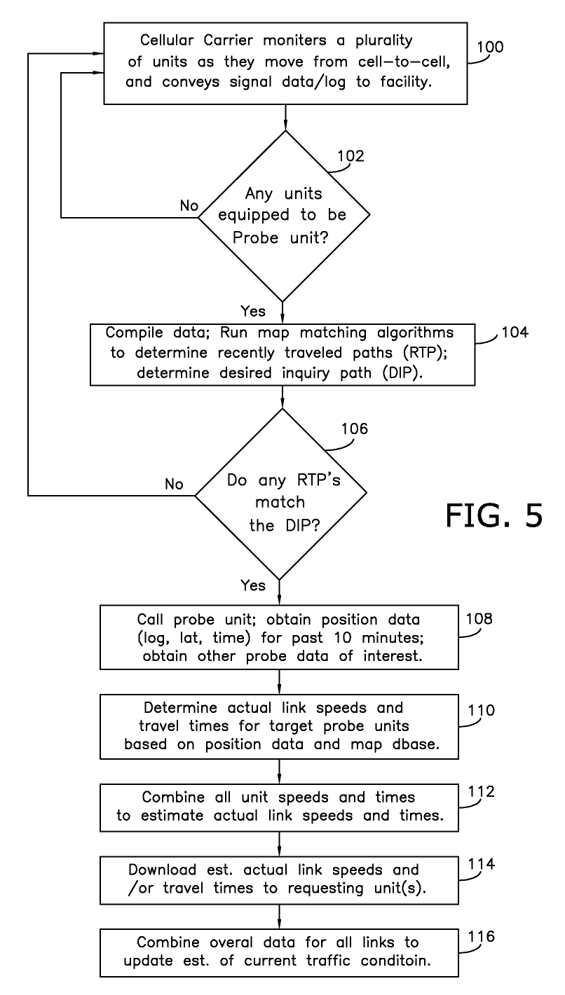

FIG. 5 presents a method of operating a system 10 in accordance with a preferred embodiment of the invention wherein the facility receives signal data from all communicating units 12, but only probe vehicle data is utilized. The method begins at a step 100, wherein a carrier 18 monitors (i.e., receives registration request signal data from and builds cell history logs for) a plurality of vehicle units 12 as they move from cell to cell. Next, at a step 102, the electronic serial numbers of the units are compared to an identification database to determine which if any units 12 are equipped to participate as a probe unit. If none, the method returns to step 100; otherwise the method proceeds to step 104, wherein the cell history log data is compiled, and map database matching algorithms are used to estimate recently traveled paths (RTP) for each equipped unit 12.

At a step 106, the facility 22 receives a request from a requesting unit 12r, determines a desired inquiry path (DIP) based on the request, and determines if the RTP for each equipped unit 12 in its database matches the DIP. If none, the method returns to step 100; otherwise, the method proceeds to step 108 where a target probe unit 12p is found and called to establish a communication link 22b. The link 22b is used to upload probe data, including position data, stored for a predetermined period (e.g., not less than 10 minutes) to the facility 22.

At a step 110, positioning data is matched to a map database comprising links, and more algorithms are ran to determine an actual link speed and travel time for each probe vehicle 12p. Next, at step 112 the actual speeds and travel times for each unit 12p on a given link are combined to more accurately estimate an overall average link speed or travel time. Finally, at a step 114, the overall average link speed or travel time is downloaded to the requesting unit 12r. More preferably, the overall link data for all links are further combined to maintain an estimate of current traffic conditions at step 116, so as to be queriable, and maintain/update maps, dynamic routing, prediction of future traffic conditions, etc.

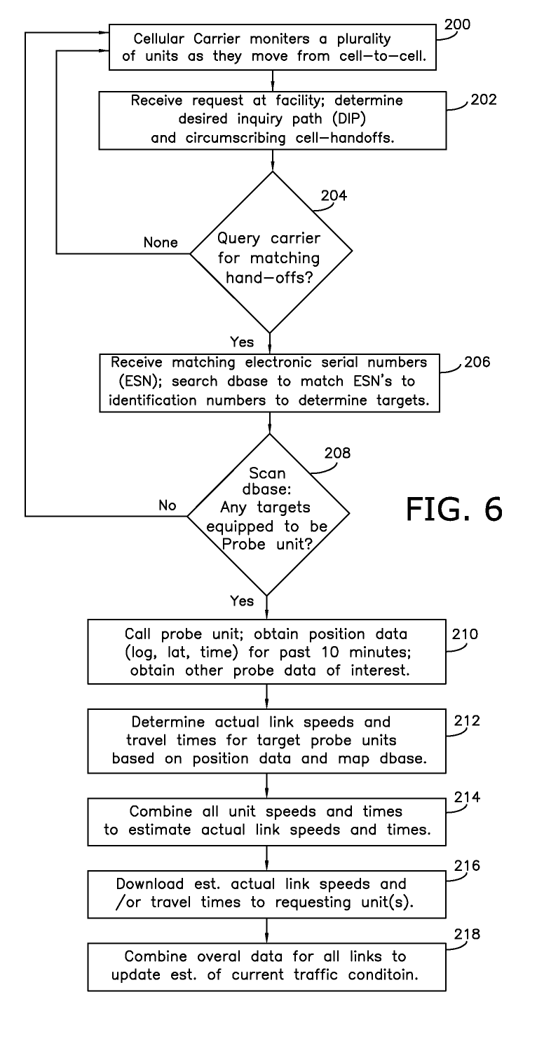

FIG. 6 presents a method of operating a system 10 wherein probe vehicular units 12p are utilized and selectively retrieved from the carrier 18. The method begins at a step 200, wherein the carrier 18 monitors a plurality of units 12 as they move from cell to cell. At step 202, the facility 22 receives a request for information, and determines a desired inquiry path and circumscribing cell hand-offs based on the request. At step 204, the facility 22 sends a query to the carrier 18 for electronic serial numbers having at least one matching hand-off within a recent period. At a step 206, the facility 18 receives a plurality of electronic serial numbers responsive to the query, and matches the serial numbers with VIN's from a database, so as to determine target units.

At step 208, the database is further scanned to determine if the target units are participating probe units 12p. If none, then the method returns to step 200; otherwise the method proceeds to step 210, wherein each probe unit 12p is called, so as to obtain probe data, including position data. At a step 212, positioning data is matched to a map database comprising links, and more algorithms are run to determine an actual link speed and travel time for each probe vehicle 12p. Next, at step 214 the actual speeds and travel times for each unit 12p on a given link are combined to more accurately estimate an overall average link speed or travel time. Finally, at a step 216, the overall average link speed or travel time is downloaded to the requesting unit 12r. More preferably, the overall link data for all links are further combined to maintain an estimate of current traffic conditions at step 218, so as to be queriable, and maintain/update maps, dynamic routing, prediction of future traffic conditions, etc.

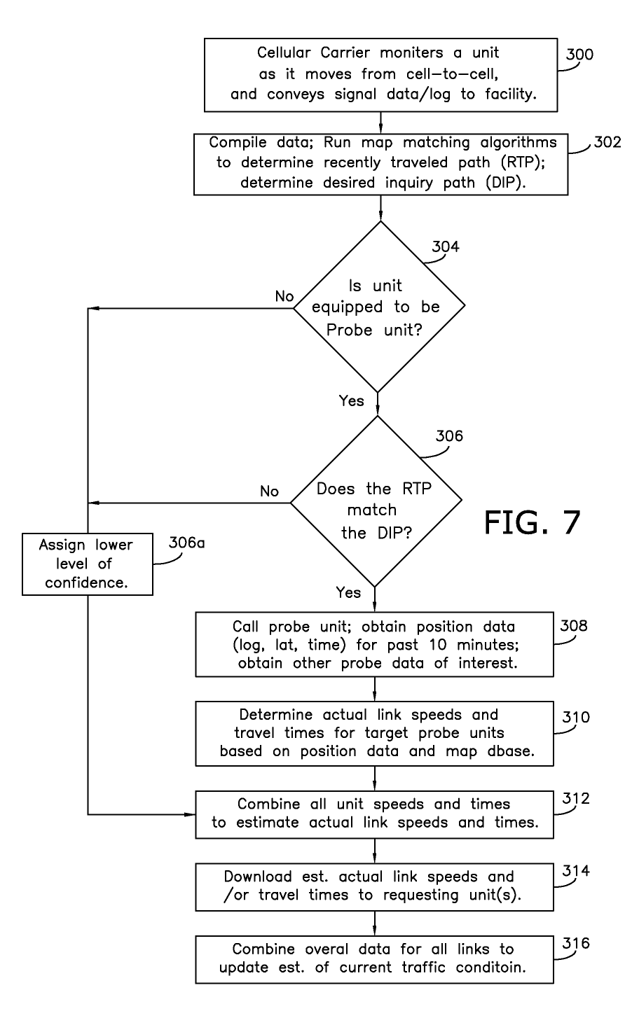

FIG. 7 presents a method of operating the system 10 wherein both target and probe vehicular units 12t,p are utilized to enhance ETT's with probe data. The method begins at a step 300, wherein the carrier 18 monitors a plurality of units 12 as they move from cell to cell. At step 302 map database matching algorithms are used to estimate recently traveled paths (RTP) for each unit 12 based on the compiled cell history log data. At step 304, the facility 22 receives a request from a requesting unit 12r, determines a desired inquiry path (DIP) based on the request, and determines if the RTP for each unit 12 in its database matches the DIP. If none, then the method returns to step 300; otherwise target units 12t are declared as the method proceeds to step 306.

At step 306, the electronic serial numbers of the target units 12t are compared to an identification database to determine which if any are also probe units 12p. If the unit 12t is not also a probe unit 12p, then at an intermediate step 306a an ETT is determined based on transmission times and locations, a lower level of confidence is assigned to it, and the method then skips to step 312. If a probe unit 12p is found at step 306, then the method proceeds to step 308 where the target probe unit 12p is called to obtain probe data, including position data.

Next, at a step 310, positioning data is matched to a map database comprising links, and more algorithms are run to determine an actual link speed and travel time for each probe vehicle 12p. At a step 312 the actual speed and travel time for each of the probe units 12p of a given link are combined with other data including the ETT's for the target units 12t to more accurately estimate an overall average link speed or travel time. Finally, at a step 314, the overall average link speed or travel time is downloaded to the requesting unit 12r. More preferably, the overall link data for all links are further combined to maintain an estimate of current traffic conditions at step 316, so as to be queriable, and maintain/update maps, dynamic routing, prediction of future traffic conditions, etc. It is appreciated that this method is useful with any number of participating probe vehicles 12p: with 0% penetration, the system reverts to the conventional hand-off-based system; as penetration increases, so do the accuracy and reliability of the estimates.

The preferred forms of the invention described above are to be used as illustration only, and should not be utilized in a limiting sense in interpreting the scope of the general inventive concept. Obvious modifications to the exemplary embodiments and methods of operation, as set forth herein, could be readily made by those skilled in the art without departing from the spirit of the present invention. The inventors hereby state their intent to rely on the Doctrine of Equivalents to determine and assess the reasonably fair scope of the present invention as pertains to any system or method not materially departing from but outside the scope of the invention as set forth in the following claims.

What is claimed is:

1. A method of collecting data from a mobile telematics unit, wherein the unit includes a cellular communication device that at least periodically causes to be transmitted a registration request signal data to a carrier, and the carrier determines a current cellular communication cell serving the unit based on the registration request signal data, and compiles a list of cells within which the unit transmitted at least once, said method comprising:
a) determining a desired inquiry path at a third party facility;
b) receiving the registration request signal data and compiling a cell history log comprising the list of cells at the carrier;
c) receiving the signal data and log at the facility;
d) determining a transmission location, a transmission time and a unit phone number based on the registration request signal data at the facility;
e) estimating a recently traveled path based on the log at the facility;
f) comparing the desired inquiry and recently traveled paths, so as to determine when at least a portion of the paths match to produce a matching path portion; and
g) determining an estimated travel time for traversing at least a portion of the matching path portion based on the signal data and log at the facility.

2. The method as claimed in claim 1,
steps (d) and (g) further comprising the steps of determining pluralities of transmission times and locations for the unit from either the signal data or log, and determining the estimated travel time as a function of the difference between the travel times and distance between the locations.

3. The method as claimed in claim 1, further comprising:
h) determining a requesting unit, and transmitting the estimated travel time to the requesting unit,
step a) further comprising the step of determining the desired inquiry path based on the request.

4. The method as claimed in claim 3,
step (h) further comprising the steps of determining actual travel time data from at least one probe unit at the facility, and combining the estimated travel time with the actual travel time data, so as to refine the estimated travel time, and transmitting the refined travel time to the requesting unit.

5. The method as claimed in claim 1,
step (b) further comprising the steps of sending a registration request signal from the unit to an intermediary monitor, appending the monitors location to the signal, so as to comprise the signal data, and transmitting the signal data to the carrier from the monitor.

6. The method as claimed in claim 1,
step (g) further comprising the steps of determining preceding, interior, and succeeding adjacent cells within which the unit transmitted plurally based on the log, where at least a portion of the matching path portion extends from the preceding cell directly through the interior cell, and then directly into the succeeding cell, so as to define a bisecting interior cell portion of said at least portion of the matching path portion; and determining an estimated travel time for said bisecting interior cell portion based on the difference between the last transmission within the preceding adjacent cell and the first transmission within the succeeding adjacent cell.

7. A method of collecting probe data from a target probe unit, wherein the unit causes registration request signal data to be transmitted to a carrier, and the carrier determines a current cellular communication cell serving the unit based on the registration request signal data, and compiles a cell history log for the unit that includes a list of the cells within which signal data was transmitted within a preceding period, said method comprising:
a) determining a desired inquiry path at a third party facility;
b) monitoring registration request signal data and compiling a cell history log for at least one unit at the carrier;
c) receiving the registration request signal data and log at the facility;
d) determining a transmission location, transmission time, unit identification number, probe unit status, and phone number based on the registration request signal data at the facility;
e) estimating a recently traveled path based on the log at the facility;
f) comparing the desired inquiry and recently traveled paths, so as to determine a target unit when at least a portion of the paths match, and further determining a target probe unit based on the probe unit status;
g) calling the target probe unit at the facility so as to establish a communication link; and
h) determining probe data at the target probe unit, and uploading the probe data to the facility.

8. The method as claimed in claim 7,
step (c) further comprising the steps of determining at least one cell hand-off of interest at the facility based on the desired inquiry path; sending a query to the facility for logs containing a hand-off of interest; and receiving the registration request signal data and log only if the log satisfied the query, at the facility, so as to selectively retrieve data from the carrier.

9. The method as claimed in claim 7, further comprising:
i) compiling and manipulating probe data uploaded from a plurality of units so as to determine an aggregate probe data value at the facility.

10. The method as claimed in claim 7, further comprising:
i) updating an overall estimate of current traffic conditions at the facility with the probe data uploaded from the unit.

11. The method as claimed in claim 7,
step (d) further comprising the step of determining the transmission location cooperatively based on the registration request signal data and at least one previously inputted cell tower location.

12. The method as claimed in claim 7,
step (d) further comprising the steps of determining an electronic serial number for the unit from the registration request signal data at the facility, and determining the unit identification number, probe unit status, and phone number by matching each item to the electronic serial number.

13. The method as claimed in claim 7, wherein the unit is housed within a vehicle, the probe data is related to at least one condition of the vehicle, and the vehicle is configured to autonomously determine the probe data.

14. The method as claimed in claim 13, wherein the probe data includes at least one condition selected from the group consisting of the current vehicular location, speed, heading, windshield wiper actuation status, and fog light actuation status.

15. The method as claimed in claim 13, wherein the vehicle maintains the probe data for a period not less than 10 minutes.

16. The method as claimed in claim 13, wherein the desired inquiry path includes a first thoroughfare segment, the estimated recently traveled path includes a second thoroughfare segment interconnecting adjacent cells within the log, and step (h) further includes the steps of uploading probe data to the facility, only when at least a portion of the first and second thoroughfare segments match.

17. The method as claimed in claim 7,
steps (a) through (c) and (h) further comprising the steps of determining a requesting unit by receiving a request including the requesting unit phone number at the facility; determining the desired inquiry path based on the request; and calling and downloading the probe data to the requesting unit from the facility.

18. The method as claimed in claim 7,
step (b) further comprising the steps of storing the current cellular communication cell in the cell history log for a period not less than 12 minutes.

19. A computer usable medium storing a computer program, and adapted for autonomous use by an electronic control unit at a third party facility, said program comprising:
computer readable code for determining a desired inquiry path;
computer readable code for actuating a monitoring device configured to monitor registration request signal data sent by at least one cellular unit;
computer readable code for actuating a receiver configured to receive the registration request signal data;
computer readable code for deriving a transmission location, a transmission time and a unit identification number from the registration request signal data;
computer readable code for actuating a communication device, so as to call the unit and establish a communication link;
computer readable code for initiating the uploading of a cell log from the unit to the facility;
computer readable code for estimating a recently traveled thoroughfare path based on the log; and
computer readable code for further initiating the uploading of probe data to the facility, where the recently traveled thoroughfare path includes the desired inquiry path.
